(19) United States
(12) Patent Application Publication
(10) Pub. No.: US 2026/0064337 A1
(43) Pub. Date: Mar. 5, 2026

(54) CHECKING PRINTOUT AT HOST DEVICE

(71) Applicant: Hewlett-Packard Development Company, L.P., Spring, TX (US)

(72) Inventors: Han Sung KIM, Seongnam Si (KR); Chang Soo PARK, Seongnam Si (KR); Jea Hong PARK, Seongnam Si (KR); Inhong CHUNG, Seongnam Si (KR); Sunkye HWANG, Seongnam Si (KR)

(21) Appl. No.: 19/107,135

(22) PCT Filed: Jan. 31, 2023
(86) PCT No.: PCT/US2023/011952

§ 371 Date: Feb. 27, 2025

(30) Foreign Application Priority Data
Sep. 2, 2022 (KR) 10-2022-0111374

(51) Int. Cl. G06F 3/12

(52) U.S. Cl. CPC G06F 3/1256; G06F 3/1204; G06F 3/1207

(57) ABSTRACT

Examples include an image forming apparatus, including; a transceiver to receive a first print job from the host device; an image former to generate a printout corresponding to at least one page of a target document of the first print job; a scanner; and a controller. The controller is to: in response to a proof print function activated for the first print job, control the scanner to generate a scan image of the printout and control the transceiver to send the scan image to the host device; and in response to reception of, from the host device, information regarding a change of a print setting for the first print job, control the image former to perform, based on the information, image generation of the first print job.

### BACKGROUND

An image forming apparatus and a host device may be connected to each other in a variety of manners so that the image forming apparatus may perform printing of print data generated at the host device. For example, the image forming apparatus may be coupled through a universal serial bus (USB) cable or the like directly to the host device and thus serve as a local image forming apparatus. In another example, the image forming apparatus may be coupled to a network environment so that a connection may be established over which the image forming apparatus and the host device communicate with each other.

### BRIEF DESCRIPTION OF THE DRAWINGS

FIG. 1 is a diagram conceptually illustrating an example of a printing system consistent with the disclosure.

FIG. 2 is a diagram illustrating an example host device consistent with the disclosure.

FIG. 3 is a diagram illustrating an example image forming apparatus consistent with the disclosure.

FIGS. 4A to 4C are, when taken together, an example flow diagram depicting a process that is performed by the example host device to support an example proof print function consistent with the disclosure.

FIGS. 5A and 5B are, when taken together, an example flow diagram depicting a process that is performed by the example image forming apparatus to support the example proof print function consistent with the disclosure.

FIG. 6 shows an example of a user interface to receive an input to activate the example proof print function consistent with the disclosure.

FIG. 7 shows an example of a user interface of an application for performing the example proof print function consistent with the disclosure.

FIG. 8 shows example user interfaces with which to select information for their respective print option items in the user interface of FIG. 7 consistent with the disclosure.

FIG. 9 is a schematic illustration of a storage medium that stores a computer program that is executable by an example image forming apparatus consistent with the disclosure.

### DETAILED DESCRIPTION

An image forming apparatus may be installed in a multi-user environment where the image forming apparatus is connected to a network and may be, in general, physically remote from a user's host device. In this environment, after transmitting a print job including print data from the host device to the image forming apparatus, the user can go to the remotely-located image forming apparatus and pick up a final printout produced by the image forming apparatus. Moreover, when he/she desires to check for a status of a test printout of the print job before the final printing thereof, the user may take the test printout at the image forming apparatus as well.

That is, in the above-mentioned scenario, where the final printout is obtained after it is checked whether the status of the test printout matches the user's intention, he/she may go back and forth between the host device and the image forming apparatus at least twice. This may be burdensome for the user. Further, if it is checked that the status of the test printout is different from that intended, a new print job may be generated by using a printer driver of the host device to generate new print data therefor. Thus, it may take a greater amount of time to get the final printout in his/her desired form, where the amount of time additionally includes: a time it takes for the printer driver to generate the new print data; a time it takes for the host device to send the generated new print job to the image forming apparatus; and a time it takes for the user to move to the image forming apparatus to check a test printout of this print job.

In contrast, examples of the present disclosure can include a host device connected over a network with a remotely located image forming apparatus that can perform a print job, and the host device may be used in checking for a status of a printout of the print job. For instance, in accordance with some examples, an image forming apparatus can support a proof print function by which, in order to check for a status of a printout produced by the image forming apparatus, a user may use his/her host device without having to move to the image forming apparatus to view the printout. For example, the user may operate the host device to generate print data regarding a target document to request the image forming apparatus to perform a print job. In response, the image forming apparatus may produce a printout corresponding to a starting page or an initial copy of the document while an image of the printout may be displayed on the host device. Thus, the user may check the displayed image and instruct the following: printing a not-yet-printed portion of the document; or printing the document with a print setting changed to his/her desired one, where such change of the print setting is made on a printer driver program of the host device or an additional application running on the host device. This may allow the user to acquiring a final printout in his/her desired form without having to go to the image forming apparatus an excessive number of times. Further, the printing of the document may be achieved with a reduced number of print jobs generated because a new print job may not be generated according to the new print setting and may be achieved in a more user-convenient manner.

Various terms used in the present disclosure are chosen from a terminology of commonly used terms in consideration of their function herein, which may be appreciated differently depending on an intention of a person, a precedent case, or an emerging new technology. In some instances, some terms are to be construed as set forth in detail in the detailed description. Accordingly, the terms used herein are to be defined consistently with their meanings in the context of the present disclosure, rather than simply by their plain and ordinary meaning.

The terms “comprising,” “including,” “having,” “containing,” etc. are used herein when specifying the presence of the elements listed thereafter. Unless otherwise indicated, these terms and variations thereof are not meant to exclude the presence or addition of other elements.

As used herein, the ordinal terms “first,” “second,” and so forth are meant to identify several similar elements. Unless otherwise specified, such terms are not intended to impose limitations, e.g., a particular order of these elements or of their use, but rather are used merely for referring to multiple elements separately. For instance, an element may be referred to in an example with the term “first” while the same element may be referred to in another example with a different ordinal number such as “second” or “third.” In such examples, such terms are not to limit the scope of the present disclosure. Also, the use of the term “and/or” in a list of multiple elements is inclusive of all possible combinations of the listed items, including any one or plurality of the items.

The term “image forming” as used herein may encompass any of a variety of image-related jobs that involve an operation of forming an image and/or other processing operations, e.g., creation, generation and/or transfer of an image file. By way of example and not limitation, an image forming device may perform an image forming job, such as a print job, a copy job, a scan job, a facsimile or other transmission job, a storage job, a coating job, or the like.

The term “image forming device” or “image forming apparatus” as used herein may encompass any of a variety of devices, such as a printer, a scanner, a facsimile machine, a multifunction printer (MFP), a display device, and the like, that are capable of performing an image forming job. In some examples, an image forming device may be a two-dimensional (2D) or three-dimensional (3D) image forming device. Such image forming device may provide various additional functions, as well as basic ones, for example, print, copy, and scan functions.

The term “user” as used herein may refer to a person/organization who manipulates an image forming device to operate an image forming job.

The terms “computing device” or “host device” as used herein may refer to any information processing device, such as, for example, a computer, a laptop, a tablet PC, a mobile telephone terminal, or the like, that may be used by a user.

Certain examples of the present disclosure will now be described in detail with reference to the accompanying drawings. The present disclosure may, however, be embodied in many different forms and should not be construed as limited to the examples set forth herein; rather, these examples are given in order to provide a better understanding of the scope of the present disclosure.

These and other features of the examples will become apparent from the following detailed description taken in conjunction with the accompanying drawings.

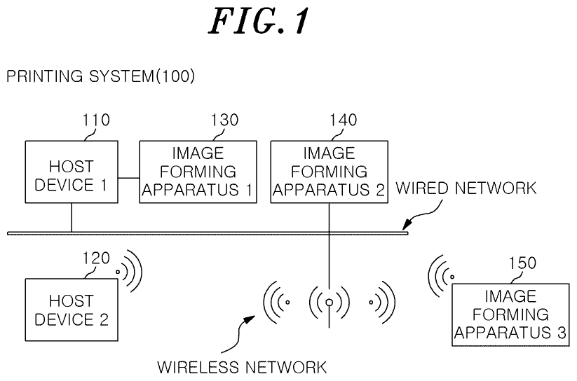

FIG. 1 is a diagram conceptually illustrating an example of a general printing system consistent with the disclosure.

As shown in FIG. 1, an example printing system 100 includes a host device, e.g., a computer 110, a mobile terminal 120, etc., and an image forming apparatus, e.g., image forming apparatuses 130, 140, and 150. The host device 110 or 120 may use print data and a print command to send a request for printing of a print job to the image forming apparatus 130, 140, or 150, which may then form an image on print paper in accordance with the print data and the print command that are received from that host device 110 or 120. The host device 110 or 120 may be attached through a USB cable or the like directly to the image forming apparatus 130, 140, or 150 or may be attached through a wired and/or wireless network to the image forming apparatus 130, 140, or 150.

The example printing system of FIG. 1 implements a function by which the host device 110 or 120 may generate and send the print data to the image forming apparatus 130, 140, or 150 for printing thereof and then display thereon an image of a result of the printing so that the image may be checked. A printing process is outlined below that may be performed when this “proof print” function is activated in the printing system of FIG. 1.

In some examples, if with the proof print function activated, the host device 110 or 120 sends the print job, including the print data and the print command, to the image forming apparatus 130, 140, or 150, then that image forming apparatus 130, 140, or 150 may produce a printout by printing a portion, e.g., a starting page or an initial copy, of a target document for which the print job is requested and may scan, with an in-line scanner, the produced printout to generate and send back a scan image to that host device 110 or 120. The host device 110 or 120 may display the received scan image such that a user may check for a quality or the like of the printout of his/her requested print job and allowing the user to select and change a print option whose type is, for example, one of the following three print option types: a page description language (PDL) item, a print image reprocessing item, and a print attribute resetting item. In accordance with the selected print option, the host device 110 or 120 may operate as follows: if the selected print option is of the PDL item or the print image reprocessing item, the host device 110 or 120 may send, to the image forming apparatus 130, 140, or 150, without transfer of new print data, a corresponding print command with which that image forming apparatus 130, 140, or 150 may use the already-stored print data to perform printing of the print job; or if the selected print option is of the print attribute resetting item, the host device 110 or 120 may invoke a printer driver program, generate a new print job, and send the new print job to the image forming apparatus 130, 140, or 150 so that the image forming apparatus 130, 140, or 150 may process this new print job. In these examples, with any print job received from the host device 110 or 120, the image forming apparatus 130, 140, or 150 may use the in-line scanner for generating a scan image, transform the scan image into a particular format, and send the formatted scan image to a particular folder of that host device 110 or 120. In response, the host device 110 or 120 may cause an application for performing the proof print function, for example, the printer driver or another application, to read the image stored in the particular folder and display the image.

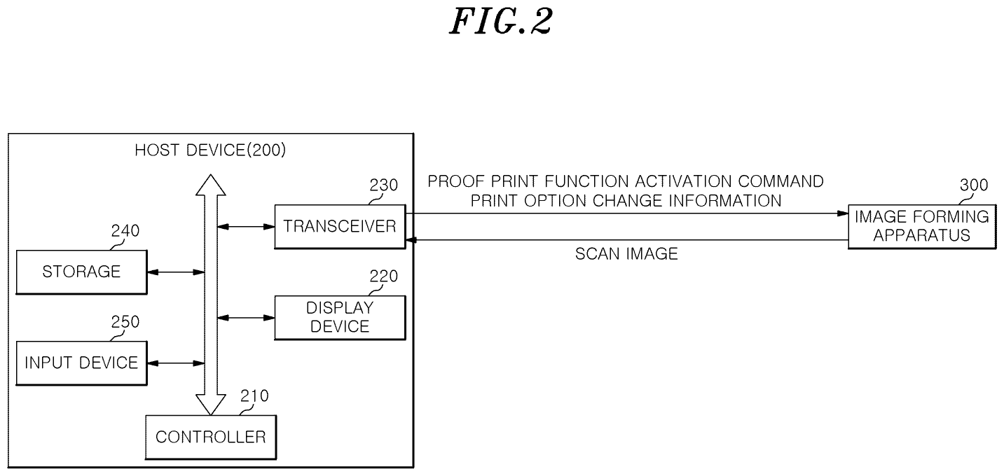

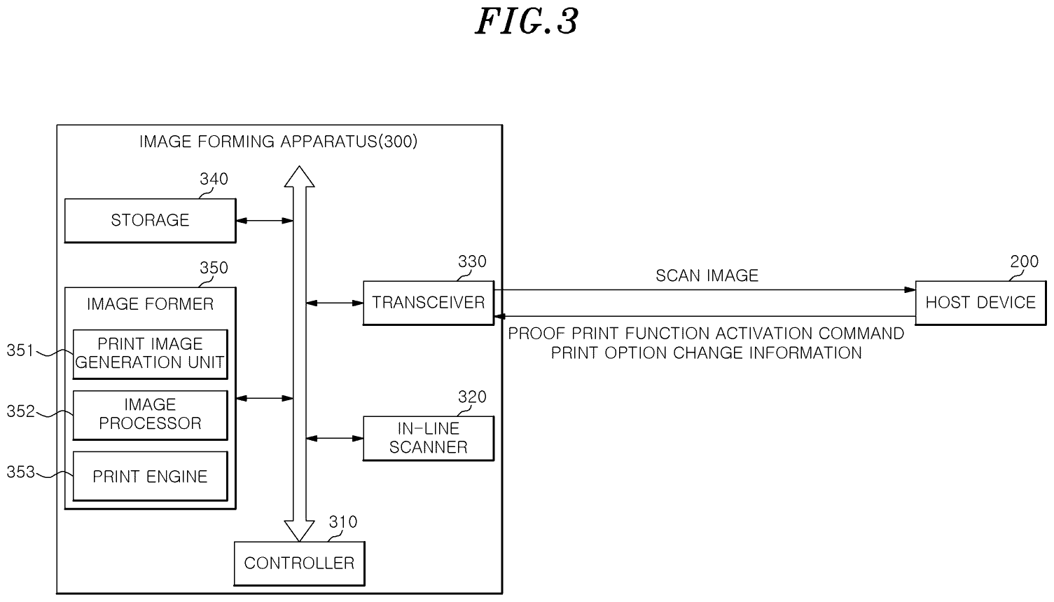

Referring now to FIGS. 2 and 3, there are described how the host devices and the image forming apparatuses of the printing system of FIG. 1 are arranged. FIG. 2 is a diagram illustrating an example host device consistent with the disclosure. FIG. 3 is a diagram illustrating an example image forming apparatus consistent with the disclosure.

As shown in FIG. 2, an example host device 200, such as the host device 110 or 120, may include a controller 210, a display device 220, a transceiver 230, a storage 240, and an input device 250. When a user runs, on the host device 200, an application such as a word processing application, an image editing application, or the like to compose a document, an image, or the like and cause an example image forming apparatus 300, such as the image forming apparatus 130, 140, or 150, to produce a printout corresponding thereto, he/she may activate the proof print function. With this function activated, the host device 200 can receive a scan image of the printout so that the user may check for an actual status of the printout without having to move to the image forming apparatus 300.

For instance, when receiving, from the user through the input device 250, an input to activate the proof print function, the controller 210 of the host device 200 may control the transceiver 230 to send to the image forming apparatus 300 a first print job including an instruction to activate the proof print function. Further, the controller 210 may control the transceiver 230 to receive from the image forming apparatus 300 a scan image of a printout of the first print job and may control the display device 220 to display thereon the received scan image. In this regard, the received scan image may be stored in the storage 240. The user may view the scan image displayed on the display device 220 to check for an actual status of the printout. If the status of the printout is different from that intended by him/her, the user may change a print option for the first print job and instruct printing a target document of the first print job again. Upon the user instruction, the controller 210 may send, to the image forming apparatus 300, information regarding the change of the print option for the first print job, where the information may include print setting change information regarding a change of a print setting for the first print job or print attribute resetting information regarding a second print job that is newly generated for the target document of the first print job.

As shown in FIG. 3, the image forming apparatus 300 may include a controller 310, an in-line scanner 320, a transceiver 330, a storage 340, and an image former 350. The image former 350 may include a print image generation unit 351, an image processor 352, and a print engine 353.

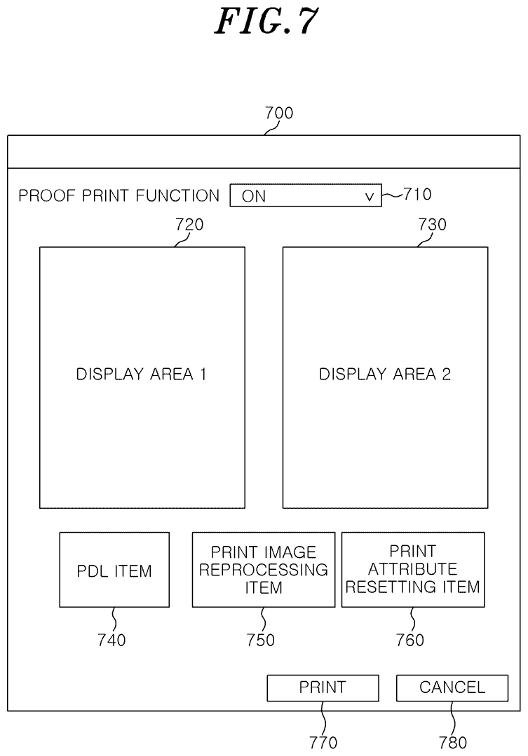

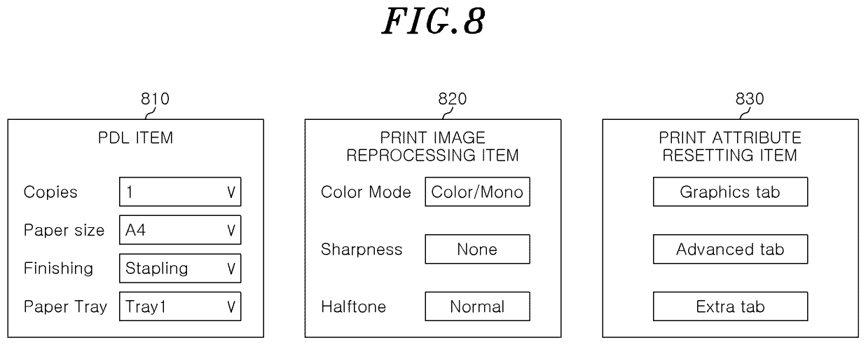

When the transceiver 330 receives a print job, e.g., the first print job including the proof print function activation instruction, from the host device 200 connected with the image forming apparatus 300, the controller 310 may determine whether the proof print function is activated. For example, upon reception of the first print job, the controller 310 may determine from the proof print function activation instruction whether the proof print function is activated. With the proof print function activated for the first print job, the controller 310 may cause the image former 350 to generate the printout as one corresponding to at least one page of the target document of the first print job. In an example where the first print job is for printing the document into a single copy, the generated printout corresponds to a starting page of the document. In an example where the first print job is for printing the document into multiple copies, the generated printout can correspond to an initial copy of the document. In such examples where the printout generated by the image former 350 corresponds to a portion of the target document of the first print job, in response to the proof print function activated for the first print job, the controller 310 may control the scanner 320 to generate the scan image of the printout and may control the transceiver 330 to send the scan image to the host device 200. Thereafter, in response to reception of, from the host device 200 through the transceiver 330, the information regarding the change of the print option for the first print job, the controller 310 may control the image former 350 to perform image generation in accordance with the print option change information. As mentioned earlier, this information may include: the print setting change information, for example, information regarding the PDL item and information regarding the print image reprocessing item; and the information regarding the print attribute resetting item, e.g., regarding the second print job generated by the host device 200 for the target document of the first print job. Further details thereof will be described below with reference to FIGS. 7 and 8. As such, in response to reception of, from the host device, the print setting change information for the first print job, the controller 310 may control the image former 350 to perform image generation of the first print job based on the received information. Likewise, in response to reception of, from the host device, the second print job generated for the target document of the first print job, the controller 310 may control the image former 350 to perform image generation of the second print job.

Thus, the image former 350 of the image forming apparatus 300 of FIG. 3 can perform the corresponding image generation in accordance with the print option change information. In some examples, the image former 350 may include the print image generation unit 351 interpreting print data received from the host device 200 and transforming the received print data into print image data having a format that can be understood by the image forming apparatus 300, for example, bitmap data; the print engine 353 forming, from the bitmap or other formatted data generated by the print image generation unit 351, an output image on a sheet of print paper picked up and fed from a paper sheet cassette; and the image processor 352 being responsible for a function of image processing of the print data or other data such as scan data.

In some examples, when receiving print data with the proof print function activated, the image forming apparatus 300 may: run its firmware for performing raster processing on the print data to generate red green blue (RGB) data; store the RGB data in the storage 340; use the image processor 352 to transform the stored RGB data into cyan, magenta, yellow, black (CMYK) data and to perform a variety of image processing operations on the CMYK data; and deliver the processed image data to the print engine 353. Examples of the image processing performed by the image processor 352 may include processing for enhancing image sharpness and processing for reducing toner scatter. Other examples of the image processing functionality of the image processor 352 are also contemplated.

The storage 340 may be a storage space for use in storage of an operating system, firmware codes, and applications that are executable on the image forming apparatus 300. In other words, the storage 340 may have stored therein a variety of data, including system data, user data, and print image data regarding a print job received from the host device 200. For example, once stored in the storage 340, the print image data may be retained therein until the print job is completed. In another example, the print image data may remain retained in the storage 340 until the user enters his/her input to delete the data. The stored print image data may be printed at any time upon user instructions. When there occurs a change of a value of a setting that corresponds to the PDL item or the print image reprocessing item for the print job with the proof print function activated, the image forming apparatus 300 may receive, from the host device 200, a print request including a print command but without print data and may apply, to the print image data that is already stored in the storage 340, the new setting value of the changed item to generate new print image data.

The image forming apparatus 300 may further include a job manager although not shown. The job manager may issue, to print jobs to be processed by the image forming apparatus, their respective job identifiers. A job identifier may be retained until its corresponding print job is completed and data related to the print job is deleted. That is, after the completion of the print job, the identifier may be deleted. For example, when receiving a print job including print data with the proof print function activated, the image forming apparatus 300 may assign a job identifier to the print job. This job identifier may be sent, together with a scan image or the like generated for the print job, from the image forming apparatus 300 to the host device 200 and/or be sent, together with a new setting value for a print option, from the host device 200 to the image forming apparatus 300, thereby allowing that print job to be identified.

As shown in FIG. 3, the in-line scanner 320 may be used as a scanner to scan a document to generate a scan image. The image forming apparatus 300 may include a paper sheet transfer path along which a sheet of print paper is transferred having an image formed thereon by the print engine 353. This paper sheet transfer path may include a path that traverses the in-line scanner 320 and a path that bypasses the in-line scanner 320. These two paths may be selectively determined as a current paper sheet transfer path. For example, the controller 310 may perform a control operation to transfer a printed sheet of paper along the traversing path for a print job when the proof print function is activated so that an image of the printed paper sheet may be checked. For a print job with the proof print function deactivated, the controller 310 may perform a control operation to transfer a printed sheet of paper along the bypassing path. The in-line scanner 320 may have an image sensor to perform, in either case, a function of scanning the printed paper sheet into an image. The scan image may be sent to the host device 200, together with the job identifier that is assigned by the job manager to the corresponding print job. The scan image may be stored as a file in a particular folder of the host device 200. The scan image file stored in the particular folder may be read out and displayed by an application for performing the proof print function.

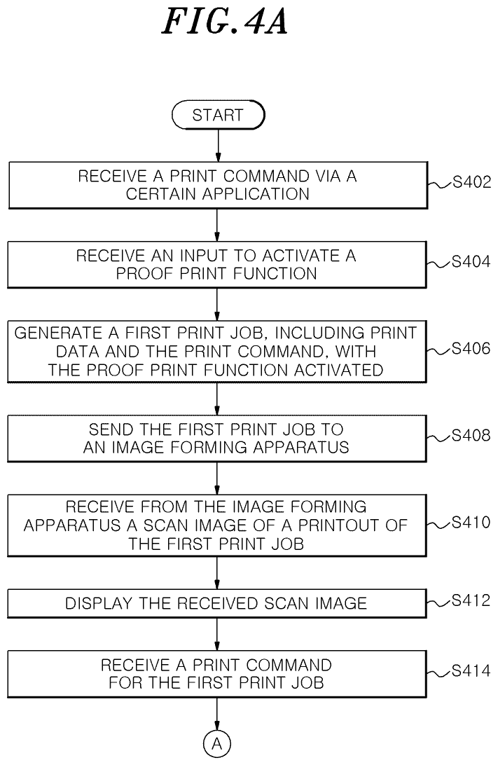

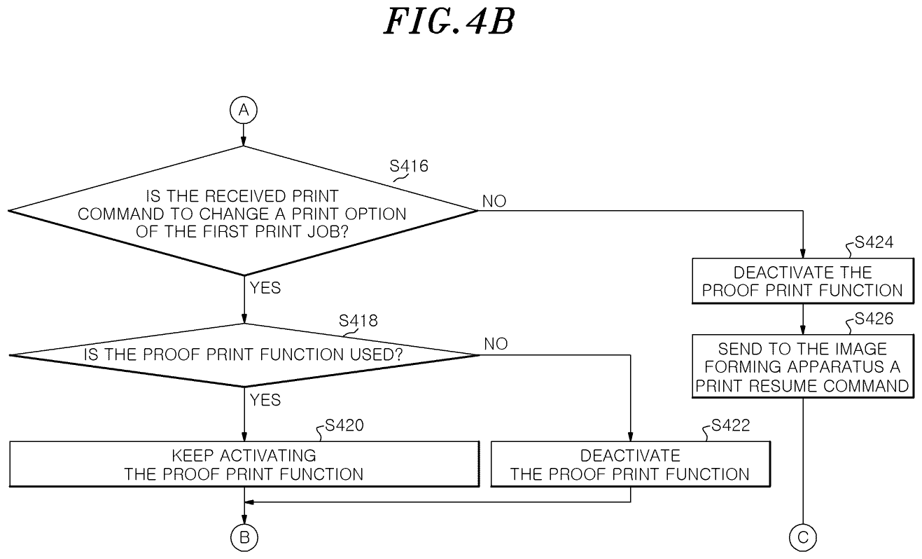

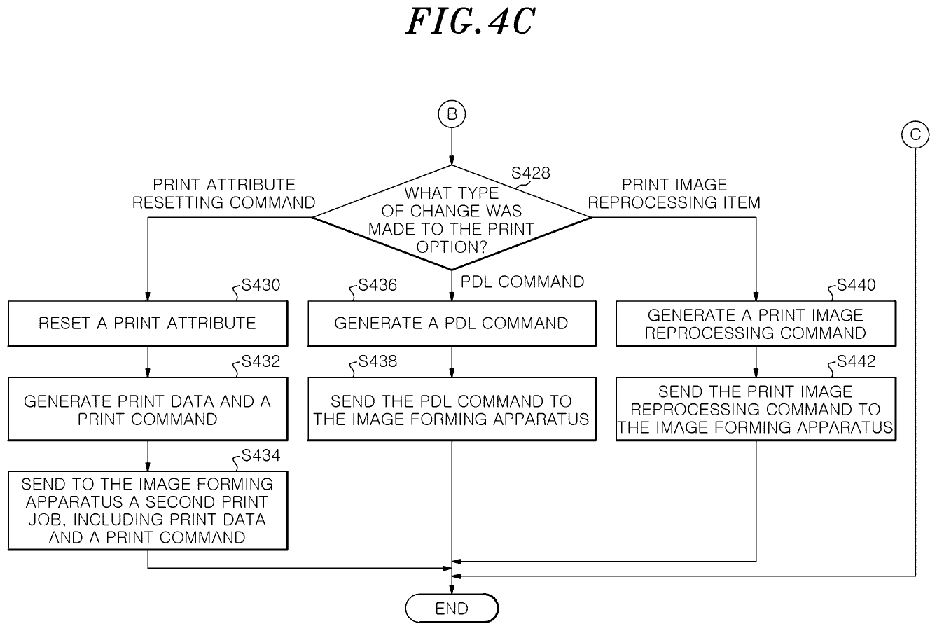

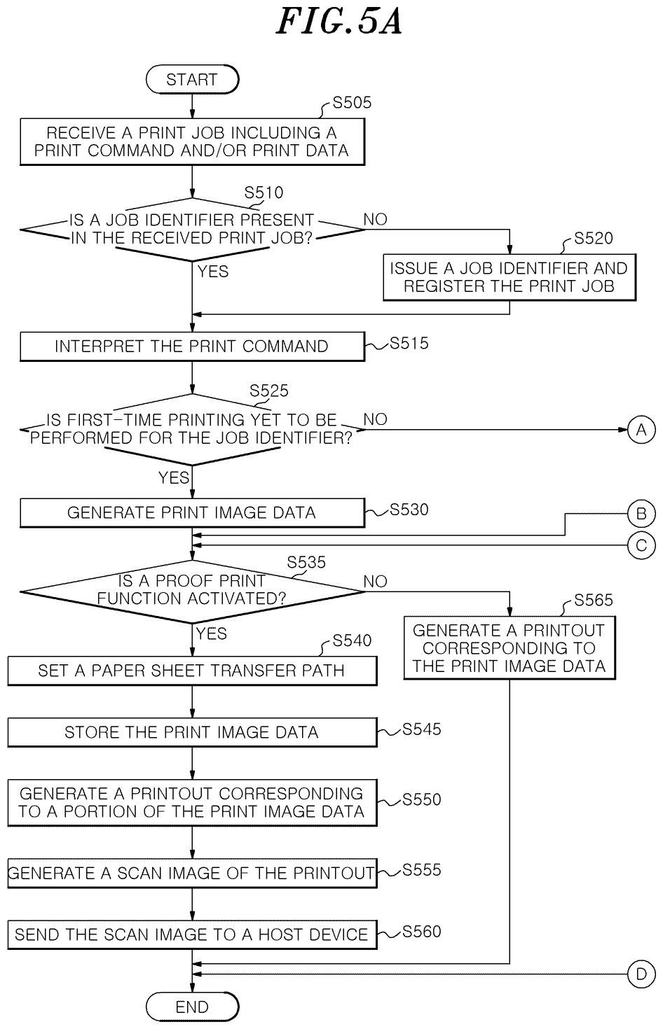

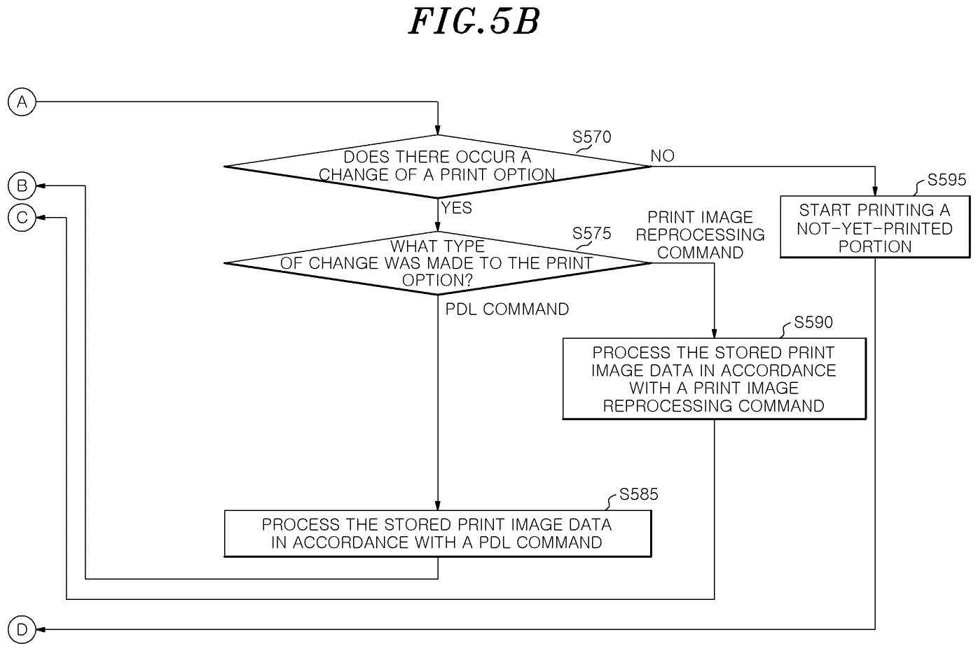

Now, with reference to FIGS. 4A to 4C, 5A and 5B, there is described how to carry out printing by using the example host device 200 and the example image forming apparatus 300 when a proof print function is activated. FIGS. 4A to 4C are, when taken together, an example flow diagram depicting a process that is performed by the example host device to support an example proof print function consistent with the disclosure. FIGS. 5A and 5B are, when taken together, an example flow diagram depicting a process that is performed by the example image forming apparatus to support the example proof print function consistent with the disclosure.

In response to the host device 200 receiving, at S402, a document print command via a certain application such as a word processing application, e.g., MS Word, an operating system of the host device 200 may invoke a printer driver program and display a user interface of the printer driver program. The host device 200 may receive, from a user through the user interface of the printer driver program, a value of a print setting or attribute, together with an input to activate the proof print function, as indicated by S404.

In response to the proof print function being activated, generating print data may include incorporating thereinto an instruction having the following format:

@PJL SET Proof Print Option=ON

The user, on the user interface, may set his/her desired print setting items and press a print button, and in response, the printer driver program may transform a document of the application into print data that is interpretable by the image forming apparatus 300 and may generate, at S406, a first print job including the print data and the print command. The host device 200 may send, at S408, the first print job to the image forming apparatus 300 through the transceiver 230.

As shown in FIG. 5A, when receiving the print job at S505, the image forming apparatus 300 may determine, at S510, whether the received print job includes a job identifier. In response to the received print job not including a job identifier (e.g., “No” at S510), the job manager of the image forming apparatus 300 may determine that the print job is newly received. Further, at S520, the job manager may issue a job identifier to the received print job and register the print job. In response to the received print job including a job identifier (e.g., “Yes” at S510), the received print job may be determined as one that has previously been processed in accordance with the activation of the proof print function and may be further processed accordingly. Regardless of whether a job identifier is present in the print job, the image forming apparatus 300 may interpret the print command at S515.

At S525, the image forming apparatus 300 may determine whether for the print job identified by the job identifier, first-time printing is yet to be performed or already performed. If first-time printing is yet to be performed (e.g., “Yes” at S525), the image forming apparatus 300 may generate print image data at S530 and determine, at S535, whether the proof print function is activated. If the proof print function is deactivated (e.g., “No” at S535), the image forming apparatus 300 may generate, at S565, a printout corresponding to the print image data. In response to the proof print function being activated (e.g., “Yes” at S535), the image forming apparatus 300 may set, at S540, a paper sheet transfer path as a path traversing the in-line scanner 320 so that the in-line scanner 320 may scan the printout. With the proof print function activated (e.g., “Yes” at S535), the image forming apparatus 300 may store, at S545, in the storage 340, the print image data generated at S530. With the proof print function activated, the stored print image data may be used when the user restarts printing the data or proceeds with printing the data with a change of the setting value. At S550, the image forming apparatus 300 may generate, using the image former 350, a printout corresponding to a portion of the print image data, for example, corresponding to a starting page or an initial copy of a plurality copies of the document. The image forming apparatus 300 may use the controller 310 to cause the generated printout to be transferred to the in-line scanner 320 and may generate, at S555, a scan image of the printout by using the in-line scanner 320. The image forming apparatus 330 may send, at S560, the generated scan image to the host device through the transceiver 330.

As shown in FIG. 4A, the host device 200 may receive, at S410, the scan image from the image forming apparatus 300. The host device 200 may display, at S412, the received scan image on a proof view tab of the printer driver program or a display area of another application. The user may check the displayed scan image. At S414, the host device 200 may receive from the user a print command for the first print job. In response to the received print command being to change a print option for the first print job (e.g., “Yes” at S416), that is, in response to the received print command corresponding to a command of the PDL type, a command of the print image reprocessing type, or a command of the print attribute resetting type, the host device 200 may keep activated the proof print function at S420 or deactivate the proof function at S422, depending on whether the proof print function is to be used (e.g., the determination made at S418). At S428, the host device 200 may determine what type of change was made to the print option. In response, the host device 200 may perform processing in accordance with the determined type.

If the changed print option is of the PDL type, the host device 200 may generate, at S436, a PDL command depending on the setting value entered by the user. At S438, the host device 200 may send, to the image forming apparatus 300, the PDL command in addition to the job identifier, which may have been received together with the scan image of the printout, without sending print data. For example, if a type of print paper is set to be changed from plain paper to pre-printed paper, the host device 200 may not generate additional print data. The host device 200 may generate data without such additional data, but with an associated PDL command. Then, the host device 200 may deliver the generated data to the image forming apparatus 300. That is, the generated data may be include the command related with the changed print setting but may not include the data to be printed.

An example of the PDL command can be given as follows, although the command may also be generated in other manners, for example, in different formats depending on what PDL is used, such as PCL, PS, XPS, or the like:

@PJL SET JOB ID=ID_0001

@PJL SET Proof Print Option=ON

@PJL SET PAPERTYPE=Pre-printed

. . .

Begin session

ubyte UpperCassette MediaSource

Begin Page

End Page

End Session

. . .

When receiving such PDL command-configured data, the image forming apparatus 300 may identify, from “@PJL SET JOB ID=ID_0001” in the received data, that “ID_0001” is the job identifier in the received PDL command. Accordingly, the image forming apparatus 300 may determine, at S525, that first-time printing is already performed for the job identifier (e.g., “No” at S525). Further, the image forming apparatus 300 may determine, at S570, that there occurs a change of the print option (e.g., “Yes” at S570). Then, as indicated by the “PDL command” branch of S575, the image forming apparatus 300 may perform processing in accordance with the PDL command. That is, based on “@PJL SET PAPERTYPE=Pre-printed” in the received PDL command data, the image forming apparatus 300 may acquire from the storage 340 the print image data identified by the same job identifier, change the print paper type from plain paper to pre-printed paper, and process, at S585, the stored print image data accordingly. In the foregoing discussion, the paper type is used as an example print setting. Other example print settings are also contemplated which do not involve a change in the print image data stored in the image forming apparatus 300.

The changed print option may be of the print image reprocessing type. Examples of the change include changing a color mode of the print job from “Color” to “Mono”, toggling whether to perform “Sharpness” processing, changing a “Halftone” table, and the like. For example, if the user changes the color mode from “Color” to “Mono”, sets the “Sharpness” processing to be performed, and selects the “Halftone” table as “Draft”, the host device 200 may not generate additional print data. The host device 200 may generate data without such additional data, but with an associated print image reprocessing command. The host device 200 may deliver the generated data to the image forming apparatus 300. That is, the generated data may include the command related with the changed print setting but may not include the data to be printed.

An example of the print image reprocessing command is given as follows, although the command may also be generated in various other manners:

@PJL SET JOB ID=ID_0001

@PJL SET Proof Print Option=ON

@PJL SET Color Mode=mono

@PJL SET Sharpness=On

@PJL SET Halftone=Draft

. . .

Begin session

Begin Page

End Page

End Session

. . .

When receiving the data including the print image reprocessing command, the image forming apparatus 300 may determine, at S525, from “@PJL SET JOB ID=ID_0001” in the received data, that first-time printing is already performed for the job identifier (e.g., “No” at S525). Further, the image forming apparatus 300 may determine, at S570, that there occurs a change of the print option (e.g., “Yes” at S570). In response, as indicated by the “print image reprocessing command” branch of S575, the image forming apparatus 300 may perform processing in accordance with the print image reprocessing command. That is, at S590, the image forming apparatus 300 may acquire from the storage 340 the print image data identified by the same job identifier and generate new print image data by changing the color mode of the print job to “Mono”, turning “On” the Sharpness processing, and setting the Halftone table to “Draft”, in accordance with the received print command.

Responsive to the changed print option being of the print attribute resetting type, the host device 200 may reset, at S430, a print attribute as reconfigured by the user. By running the printer driver program, the host device 200 may generate, at S432, new print data and a new print command in accordance with the reset print attribute. At S434, the host device 200 may send, to the image forming apparatus 300 through the transceiver 230, a second print job including the print data and the print command that are generated at S432. When sending the second print job to the image forming apparatus 300 at S434, the host device 200 may not send a job identifier since the second print job is a new one and different from the first print job.

For example, the user may add a watermark setting for the original print data. Then, the new print data may be generated including the following PDL command:

@PJL SET Proof Print Option=ON

. . .

Begin session

Begin Page

. . .

When receiving the second print job, the image forming apparatus 300 may determine, at S510, that a job identifier is not present (e.g., “No” at S510). At S520, the image forming apparatus 300 may issue a job identifier to the second print job and register this new print job. In response, the image forming apparatus 300 may interpret, at S515, the print command of the second print job and determine that first-time printing is yet to be performed for the job identifier (e.g., “Yes” at S525). At S530, the image forming apparatus 300 may generate print image data.

If the user checks a scan image of a printout of this generated data and instructs continued printing of the data with the print option unchanged (e.g., “No” at S416), the host device 200 may deactivate, at S424, the proof print function and send, at S426, a print resume command to the image forming apparatus 300. For example, the following print resume command may be delivered to the image forming apparatus 300.

@PJL SET JOB ID=ID_0001

@PJL SET Proof Print Option=OFF

@PJL SET START PAGE=2

. . .

Begin session

Begin Page

End Page

. . .

End Session

. . .

When receiving the data that does not include a change of the print option (e.g., “No” at S570), the image forming apparatus 300 may not perform a scan job anymore and may start, at S595, printing a not-yet-printed portion of the document based on the print image data stored in the storage 340 of the image forming apparatus 300. If, for example, the command contains the “@PJL SET START PAGE=2” instruction as illustrated above, the printing of the document may be resumed from a next-to-starting page of the document and continued until an ending page of the document.

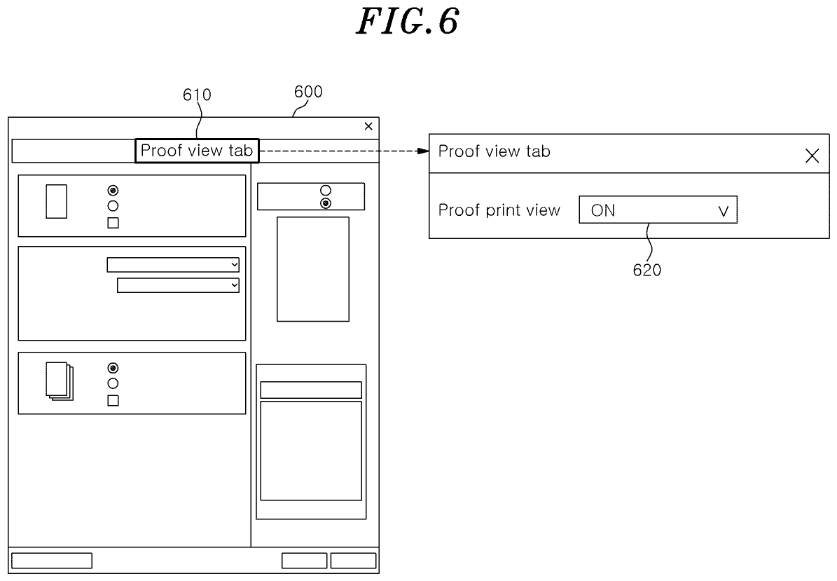

The mechanism for performing a print job with the proof print function activated is further described below, in conjunction with illustrations of example user interfaces, with reference to FIGS. 6 to 8. FIG. 6 shows an example of a user interface to receive an input to activate the example proof print function consistent with the disclosure. FIG. 7 shows an example of a user interface of an application for performing the example proof print function consistent with the disclosure. FIG. 8 shows example user interfaces with which to select information for their respective print option items in the user interface of FIG. 7 consistent with the disclosure.

As illustrated in FIG. 6, an example user interface screen 600 of the printer driver program may provide a plurality of tabs, each of which shows a respective item in which a print option is allowed to be set. The proof print function may be activated through the user interface screen 600. FIG. 6 shows that the plurality of tabs may include a proof view tab 610 for use in serving the proof print function. The proof print function may be activated by toggling “ON” a proof print view 620 of the proof view tab 610. Although in the example of FIG. 6, the proof print function is selected through the printer driver program, such selection may be made using an additional application, rather than the printer driver program, as shown in FIG. 7.

When the user toggles “ON” the proof print view 620 and instructs printing, a first print job including print data and a print command may be sent to the image forming apparatus 300. The image forming apparatus 300 may: generate print image data based on the received first print job; store the print image data; print out a portion of a target document of the first print job; generate a scan image of the printout; and send the scan image to the host device 200.

When receiving the scan image of the printout of the first print job through the transceiver 230, the controller 210 of the host device 200 may display the scan image on the display device 220. Further details of these operations are described with reference to FIG. 7, which illustrates an example user interface 700 of an application for performing the example proof print function. In the example of FIG. 7, the proof print function may be activated through this application, which is different from the printer driver program. The application may display the scan image received from the image forming apparatus and may receive from the user an input to change a print option. Other examples are also contemplated herein. For example, the user interface 700 may be implemented on the proof view tab 610 of the printer driver program 600.

The user interface 700 of FIG. 7 may include a screen that is arranged as follows.

The screen of the user interface 700 may include a menu 710 with which to activate the proof print function. The user may select between “ON” and “OFF” on the menu to activate or deactivate the proof print function.

The screen of the user interface 700 may include at least one display area in which an image may be displayed. In FIG. 7, the screen is illustrated as including two display areas 720 and 730, also referred to as Display Area 1 and Display Area 2, respectively. For example, there may be displayed on Display Area 1 an image that is output from a software-based simulation using the print data generated at the host device 200. Further, Display Area 2 is where the scan image of the actual printout produced by the image forming apparatus 300 may be displayed. The user may compare the image displayed on Display Area 1 to that on Display Area 2, thereby checking whether the actual printout is produced as intended by him/her. For example, it may be checked whether a quality of the printout is lower than that intended and/or whether the printout includes a particular piece of information, such as a watermark, a corporate logo, or the like. Although there are included two display areas in the example of FIG. 7, the user interface screen may have a different number of display areas, for example, a single display area such as the display area on which the scan image received from the image forming apparatus 300 is displayed.

The screen of the user interface 700 may include menus 740, 750, and 760, with each of which the user may change a print option on an as-needed basis after, for example, he/she checks the scan image on the display area 730. Each of these menus represents a respective item in which a print option may be set to a new value. For example, as shown in FIG. 7, the menus 740, 750, and 760 may be used to set the PDL item, the print image reprocessing item, and the print attribute resetting item, respectively.

Details of these menus are further discussed with reference to FIG. 8, where there are shown example user interfaces with which to select information for their respective print option items shown in the user interface of FIG. 7.

FIG. 8 illustrates a “PDL Item” user interface 810 including a list of settings, the change of any one of which involves resetting of a PDL command, e.g., generation of a new PDL command. Upon change of at least one of the settings, the image forming apparatus 300 may be provided with a value of the changed setting. In response, the image forming apparatus 300 may interpret the PDL command and use the print engine to form an image on print paper by, for example, processing the to-be-printed, print image data so that the document may be printed from a starting page thereof or a not-yet-printed portion thereof may be printed, in accordance with the interpreted command. As shown in FIG. 8, examples of the settings listed on the user interface 810 may include: a setting of a total number of copies to be printed, denoted as “Copies”; a setting of a size of a sheet of print paper used, denoted as “Paper size”; a setting of which processing to perform on a resulting printout, denoted as “Finishing,” where this setting may have a value of, e.g., “Stapling,” indicating that the printout is to be stapled; and a setting of which print paper tray to use, denoted as “Paper Tray”; and the like. In an example, the user may change the total number of copies by pressing the “Copies” button on the user interface 810 to increase or decrease the number as needed. In an example, when the user desires to perform printing on a pre-printed type of paper including a particular piece of information, a logo, or the like, he/she may press the “Paper Tray” button on the user interface 810 to select a proper paper tray in which sheets of the pre-printed type of paper are loaded. In this example, when the user presses the “Paper Tray” button and changes the type of print paper from plain paper to pre-printed paper, the host device 200 may not generate additional print data. Instead, the host device 200 may generate data without such additional data, but with a PDL command associated with the option changed by the user. Then, the host device 200 may deliver the generated data to the image forming apparatus 300.

FIG. 8 further illustrates a “Print Image Reprocessing Item” user interface 820 including a list of settings, each of which is provided as a parameter to the image processor 352, implemented in hardware, software, machine readable instructions, etc., or in combination thereof, when the print image data stored in the image forming apparatus 300 is input to the image processor 352. If one of the settings is changed, the image processor 352 of the image forming apparatus 300 may reprocess the print image data. That is, the image processor 352 may generate new print image data in accordance with the new setting parameter. As shown in FIG. 8, examples of the settings listed on the user interface 820 may include: a setting of which color mode to use, denoted as “Color Mode”, where this setting may be selected between, e.g., Color and Mono; a setting of whether to perform image sharpness processing, denoted as “Sharpness”; a setting of which halftone table to use, denoted as “Halftone”; and the like. For example, when the user uses the user interface 820 to change the color mode from “Color” to “Mono”, turn “On” the “Sharpness” processing, and set the “Halftone” table as “Draft”, the image processor 352 may use these new setting values as parameters to process the print image data retained in the storage 340, e.g., apply the new parameter values to the stored print image data to generate new print image data.

In addition, FIG. 8 illustrates a “Print Attribute Resetting Item” user interface 830 with which to reset a print attribute, other than those listed in the user interfaces 810 and 820, to obtain his/her desired printout, where the resetting involves using the printer driver program to generate new print data. For example, the user may add into the print data a setting of a watermark, as needed, by clicking the “Print Attribute Resetting Item” button 760 of FIG. 7 and then selecting the “Extra tab” of the user interface 830 of FIG. 8 to view a screen on which to add the watermark setting. In this manner, the user may select one of available settings in the user interface 830 and start the printing. Then, the application for performing the proof print function may deliver, to the printer driver program, information regarding the changed print setting and information regarding the print job so that the printer driver program may generate new print data.

The screen of the user interface 700 may include a “Print” button 770 and a “Cancel” button 780. After changing a print option for the first print job, the user may resume the printing by clicking the “Print” button 770. The user may instead cancel the print job by clicking the “Cancel” button 780.

When pressing the “Print” button 770 to resume the printing, the application for performing the proof print function may operate as follows: when a setting in the PDL item or in the print image reprocessing item is changed to have a new value, the application may send, to the image forming apparatus 300, the new print command and the job identifier that identifies the print job and that is previously received from the image forming apparatus 300; and when a setting in the print attribute resetting item is changed to have a new value, the application may deliver, to the printer driver program, information regarding the print job and information regarding the change of the print attribute so that the printer driver program may generate and send new print data to the image forming apparatus 300.

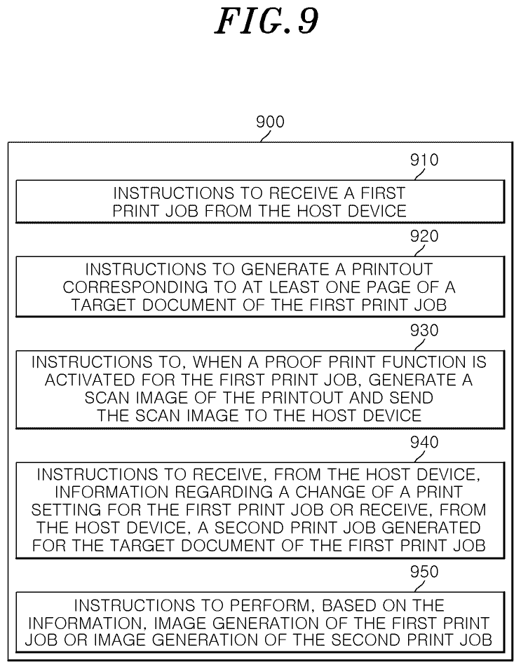

FIG. 9 illustrates a computer readable storage medium 900 having stored therein a computer program that is executable by an example image forming apparatus, e.g., the image forming apparatus 300, to perform specific operations consistent with the disclosure. Now, with reference to FIG. 9, details of the computer program stored in the computer readable storage medium 900 will be described.

As shown in FIG. 9, the computer program includes instructions that when executed by the example image forming apparatus, cause the image forming apparatus to perform operations. For instance, the instructions may include: instructions 910 to receive a first print job from the host device and instructions 920 to generate a printout corresponding to at least one page of a target document of the first print job. The instructions may include instructions 930 to, when a proof print function is activated for the first print job, generate a scan image of the printout and send the scan image to the host device. The instructions may also include instructions 940 to receive, from the host device, information regarding a change of a print setting for the first print job or receive, from the host device, a second print job generated form the target document of the first print job, and instructions 950 to perform, based on the information, image generation of the first print job or perform image generation of the second print job.

Upon execution of the computer program stored in the computer readable storage medium 900, the instructions 910 to 950 illustrated in FIG. 9, as well as the operations or the method described above with respect to FIGS. 1 to 8, may be performed by a computer, for example, the above-described image forming apparatus 300. For further details thereon, reference should be made to the above description.

The above-described computer readable recording medium may be a non-transitory readable medium. The term “non-transitory readable medium” as used herein refers to a medium that is capable of semi-permanently storing data and is readable by an apparatus, rather than a medium, e.g., a register, a cache, a volatile memory device, etc., that temporarily stores data. For example, the foregoing program instructions may be stored and provided in a CD, a DVD, a hard disk, a Blu-ray disc, a USB, a memory card, a ROM device, or any of other types of non-transitory readable media.

In a particular example, the methodology disclosed herein may be incorporated into a computer program product. The computer program product may be available as a product for trading between a seller and a buyer. The computer program product may be distributed in the form of a machine-readable storage medium, e.g., compact disc read only memory (CD-ROM), or distributed online through an application store, e.g., PlayStore™. For the online distribution, at least a portion of the computer program product may be temporarily stored, or temporarily created, in a storage medium such as a server of the manufacturer, a server of the application store, or a storage medium such as memory of a relay server.

The foregoing description has been presented to illustrate and describe some examples in detail. Modifications and variations are possible in light of the above teaching. In various examples, suitable results may be achieved if the above-described techniques are performed in a different order, and/or if some of the components of the above-described systems, architectures, devices, circuits, and the like are coupled or combined in a different manner or substituted for or replaced by other components or equivalents thereof.

Therefore, the scope of the disclosure is not to be limited to the precise form disclosed, but rather defined by the following claims and equivalents thereof.

What is claimed is:

1. An image forming apparatus connectable to a host device, comprising:
a transceiver to receive a first print job from the host device;
an image former to generate a printout corresponding to at least one page of a target document of the first print job;
a scanner; and
a controller to:
in response to a proof print function being activated for the first print job, control the scanner to generate a scan image of the printout and control the transceiver to send the scan image to the host device; and
in response to reception of, from the host device, information regarding a change of a print setting for the first print job, control the image former to perform, based on the information, image generation of the first print job.

2. The image forming apparatus of claim 1, comprising the image former to, in response to reception of, from the host device, a second print job generated for the target document, perform image generation of the second print job.

3. The image forming apparatus of claim 2, further comprising:
a job manager to assign, to the first and the second print jobs, respectively corresponding job identifiers.

4. The image forming apparatus of claim 1, comprising the image former to:
generate a printout corresponding to the first page of the target document of the first print job; or
responsive to the first print job being a job for printing the target document into a plurality of copies, generate a printout corresponding to one of the plurality of copies.

5. The image forming apparatus of claim 1, wherein the information comprises information regarding a change of a setting for a page description language (PDL) command or information regarding a change of a setting for print image reprocessing.

6. The image forming apparatus of claim 1, wherein the scanner is an in-line scanner.

7. A non-transitory computer readable storage medium having stored therein a computer program that when executed by a processor of an image forming apparatus, causes the image forming apparatus to:
receive a first print job from the host device;
generate a printout corresponding to at least one page of a target document of the first print job;
in response to a proof print function being activated for the first print job, generate a scan image of the printout and send the scan image to the host device;
receive, from the host device, information regarding a change of a print setting for the first print job or receive or, from the host device, a second print job generated for the target document; and
perform, based on the information, image generation of the first print job or perform image generation of the second print job.

8. The non-transitory computer readable storage medium of claim 7, wherein the computer program further causes the image forming apparatus to:
assign, to the first and the second print jobs, respective corresponding job identifiers.

9. The non-transitory computer readable storage medium of claim 7, wherein the computer program further causes the image forming apparatus to:
generate a printout corresponding to a starting page of the target document of the first print job; or
responsive to the first print job being a job for printing the target document into a plurality of copies, generate a printout corresponding to one of the plurality of copies.

10. A host device connectable to an image forming apparatus, comprising:
a display device;
a transceiver;
an input device; and
a controller to:
control the input device to receive an input to activate a proof print function;
control the transceiver to send a first print job to the image forming apparatus and to receive from the image forming apparatus a scan image of a printout of the first print job;
control the display device to display the scan image; and
control the transceiver to send, to the image forming apparatus, information regarding a change of a print setting for the first print job or to send, to the image forming apparatus, a second print job generated for a target document of the first print job.

11. The host device of claim 10, comprising the display device to provide a user interface screen including an area for displaying the scan image and a portion for receiving an input to change a print option for the first print job.

12. The host device of claim 11, wherein the user interface screen is provided in a user interface for a printer driver program or in a user interface of an application that is different from the printer driver program.

13. The host device of claim 10, wherein the information includes information regarding a change of a setting for a PDL command or information regarding a change of a setting for print image reprocessing.

14. The host device of claim 13, wherein the information regarding a change of a setting for a PDL command includes information regarding at least one of a total number of copies to be printed, a size of a sheet of print paper to be used, and a print paper tray to be used, and wherein the information regarding a change of a setting for print image reprocessing includes information regarding at least one of a color mode, whether to perform sharpness processing, and a halftone table.

15. The host device of claim 10, wherein the controller is to, if there does not occur the change of the print setting for the first print job and there is not generated the second print job, deactivate the proof print function and send a print resume command to the image forming apparatus.
